(19) United States
(12) Patent Application Publication
(10) Pub. No.: US 2026/0243558 A1
(43) Pub. Date: Aug. 20, 2026

(54) DISPLACEMENT INVERSION METHOD FOR DEEPWATER RISER STRUCTURE

(71) Applicant: Ocean University of China, Qingdao (CN)

(72) Inventors: Yufeng Jiang, Qingdao (CN); Yan Zhu, Qingdao (CN); Yu Liu, Qingdao (CN); Shuqing Wang, Qingdao (CN); Qi Chen, Qingdao (CN)

(21) Appl. No.: 19/291,533

(22) Filed: Aug. 5, 2025

(30) Foreign Application Priority Data
Feb. 19, 2025 (CN) 202510179420.9

(51) Int. Cl. G01B 7/28; G01B 7/004

(52) U.S. Cl. CPC G01B 7/28; G01B 7/004

(57) ABSTRACT

Disclosed is a displacement inversion method for a deepwater riser structure, including the steps of: performing real-time collection and measurement of sparse discrete curvature data; acquiring continuous curvature data using an interpolation method; generating a continuous curve, and performing real-time partition on this curve to obtain lengths of infinitesimal segments; acquiring relative position information between a riser mid-section and a surface platform, deriving a lower segment's continuous curve equation through recursive progression from a bottom end toward the mid-section, while deriving an upper segment's continuous curve equation through recursive progression from the surface toward the mid-section, integrating the upper and lower segments to obtain a full-length continuous curve equation, and calculating y at any position x. The displacement inversion is achieved by relying on real-time monitored curvature data, demonstrating strong adaptability. Furthermore, an end-error elimination strategy may solve the problem of cumulative error amplification at ends during the recursive progression.

### CROSS-REFERENCE TO RELATED APPLICATION

This application claims priority of Chinese Patent Application No. 202510179420.9, filed on Feb. 19, 2025, the entire contents of which are incorporated herein by reference.

### TECHNICAL FIELD

The present disclosure belongs to the technical field of computer-based data processing for health monitoring of deepwater riser structures, and in particular to a displacement inversion method for a deepwater riser structure.

### BACKGROUND

A deepwater riser serves as a critical structural component connecting offshore platforms to subsea production systems, with extensive applications in marine hydrocarbon extraction and related domains. The marine environment is characterized by high complexity and uncertainty. Risers are subjected to various loads, including waves, currents, tides, and seismic activity, while facing challenges such as seawater corrosion and marine biofouling. These factors result in complex displacements and deformations of the riser, imposing significant challenges to its structural integrity. Once failure occurs, it will cause substantial economic losses and severe environmental pollution. To gain a better understanding of the mechanical behavior of risers under actual operating conditions, effective displacement inversion methods are required to ascertain true displacement states. This is crucial for ensuring the safety and efficiency of marine resource development operations.

Traditional structural safety assessment methods based on theoretical calculations and empirical formulas have significant limitations, making it challenging to accurately consider the various complex factors and accidental loads present in actual marine environments. Real-time acquisition of actual riser displacement is achieved through displacement inversion, providing a more accurate and reliable basis for structural safety assessment, thereby enabling timely identification of potential safety hazards and implementation of effective maintenance and repair measures. With recent advancements in sensor technology, data acquisition, and transmission systems, extensive monitoring data of deepwater risers, such as strain, acceleration, and inclination measurements, has become accessible, providing a foundational resource for displacement inversion methodology research, thereby achieving structural displacement inversion through monitoring data analysis and processing.

Accurate displacement inversion can provide real-time insight into the actual deformation of deepwater risers under various loads and and promptly detect abnormal displacements and potential damage, providing key information for structural safety warnings and risk assessments, and helping to prevent catastrophic incidents such as riser fractures and leaks, thereby ensuring the safe operation of marine engineering facilities. At the same time, a detailed analysis of the displacement inversion results can provide insights into the mechanical performance and response characteristics of deepwater risers during actual use, thereby providing a basis for the optimized design and efficient maintenance of the risers.

Direct measurement of the complete vibration data for deepwater riser structures is highly challenging due to combined limitations in measurement techniques, testing complexity, and economic costs. In model testing and engineering applications, limited sensors are typically arranged at typical positions to obtain information such as structural strain, acceleration, and tilt angle. Various methods are employed to invert the vibration displacement at any position within the structure, achieving spatial configuration monitoring and visualization. Existing displacement inversion methods mainly include vision-based detection methods, modal superposition methods, fiber optic shape sensing (FOSS), and spatial curve reconstruction techniques, among others. The use of the vision-based detection methods for structural morphology detection and inversion is a relatively mature technology that has been widely applied to displacement reconstruction in skin/wing structures and civil engineering. However, the methods require the acquisition of massive visual data and involve complex data analysis algorithms, exhibiting significant inadaptability in marine environments. The modal superposition method involves inverting structural displacements through linear superposition of different modal shapes. Its primary application lies in inverting vortex-induced vibration displacements of deepwater riser structures, widely used in model testing scenarios. However, it requires the calculation of various modal shapes and mandates that the number of monitoring points exceeds the number of modal shapes, resulting in a cumbersome modal calculation process. FOSS represents the latest research direction in fiber optic sensing technology. It utilizes multiple spatially arranged fiber bundles to measure the position and shape of fibers or connected target objects. This method is primarily applied in scenarios such as medical minimally invasive catheter tracking. However, for kilometer-scale long-distance structural displacement monitoring of risers/submarine cables, achieving high-precision displacement inversion remains technically challenging, with no directly applicable commercial products currently available. The spatial curve reconstruction method involves converting the measured strain data into curvature information based on the linear relationship between strain and curvature under the plane section assumption. Curvature values at discrete points are obtained through interpolation, followed by piecewise integration and recursive calculation of endpoint coordinates for each segment. The displacement or deformation inversion of the structure is achieved through final curve fitting. However, due to error accumulation and amplification effects inherent in the point-by-point recursion process, the maximum error occurs at the farthest end of the reconstructed curve.

An invention patent, CN202410549330.X, provides a recursive configuration inversion method for non-metallic flexible hybrid risers. This method involves establishing a neural network model using relative positions between mining vessels and collectors and tilt angles at typical pipe segment positions as a training dataset. However, the model relies on specific, predetermined structural properties and dimensional parameters of the deep-sea mining riser system. In actual sea conditions, a structural configuration of the deepwater riser often deviates from design-phase specifications. Consequently, applying a pre-trained model to real-world riser structures introduces inherent modeling and dimensional errors. Furthermore, simplification errors are inevitably introduced when relying on offshore engineering software simulations, resulting in significant limitations in the practical application under real sea states.

### SUMMARY

In response to the above problems, the present disclosure provides a displacement inversion method for a deepwater riser structure, including the steps of:
S1, performing real-time collection and measurement of sparse discrete curvature data based on n curvature sensors mounted at a plurality of monitoring points of significant curvatures along a deepwater riser structure;
S2, acquiring m pieces of continuous curvature data using an interpolation method;
S3, generating a continuous curve based on the m pieces of continuous curvature data and positional information, and performing real-time partition on the continuous curve to obtain lengths s of m+1 infinitesimal segments; and
S4, acquiring relative position information between a riser mid-section and a surface platform, deriving a lower segment's continuous curve equation through recursive progression from a bottom end toward the mid-section, while deriving an upper segment's continuous curve equation through recursive progression from the surface toward the mid-section, integrating the upper and lower segments to obtain a full-length continuous curve equation, and calculating y at any position x, with y representing inverted displacement data corresponding to an outer side of the deepwater riser structure.

Preferably, in S2, the acquiring m pieces of continuous curvature data using an interpolation method specifically includes the steps of:
performing curvature interpolation on n measured discrete curvature data using the piecewise cubic Hermite interpolation method, based on the measured discrete curvature data

$${ρ}_{1}^{*} , {ρ}_{2}^{*} , … , {ρ}_{j}^{*} , … , {ρ}_{n}^{*}$$

and corresponding monitoring points, and acquiring m interpolated continuous curvature data ρ₁, ρ₂, . . . , ρᵢ, . . . , ρₘ, where ρᵢ represents ith interpolated curvature data, and the number of interpolated curvature data m is defined as m=n×2+1, with n representing the number of monitoring points.

Preferably, a specific process of S4 includes the steps of:
S41, acquiring the relative position information between the riser mid-section and the surface platform, wherein:
based on bottom position beacon information (x_{bot},y_{bot}) of the deepwater riser, mid-section position beacon information (x_{mid},y_{mid}) of the riser, and surface offshore platform position global position system (GPS)-derived information (xₛᵤᵣ,yₛᵤᵣ), a riser mid-section relative position

$$( {x}_{mid}^{*} , {y}_{mid}^{*} )$$

and a surface platform relative position

$$( {x}_{sur}^{*} , {y}_{sur}^{*} )$$

are calculated with a coordinate origin (0,0) at the bottom position of the deepwater riser, where these relative positions satisfy the following relationships:

$${x}_{mid}^{*} = {x}_{mid} - {x}_{bot} , {y}_{mid}^{*} = {y}_{mid} - {y}_{bot} ,$$

$${x}_{sur}^{*} = {x}_{sur} - {x}_{bot} , and {y}_{sur}^{*} = {y}_{sur} - {y}_{bot} ;$$

S42, deriving the lower segment's continuous curve equation through the recursive progression from the bottom end toward the mid-section, wherein:
a coordinate system is established with the coordinate origin at a riser bottom-end position, with a tangent direction at a starting point defined as an x-axis, and a vertical line at the starting point defined as a y-axis; and an infinitesimal arc length between two points on the continuous curve is denoted as s, Pᵢ represents an ith interpolation point, Oᵢ and ρᵢ represent a center of an ith infinitesimal arc segment and curvature data (or a curvature radius), and θᵢ represents an included angle between Pᵢ Oᵢ and a horizontal line;
coordinates of a center O₁(O₁ₓ,O_{1y}) of a first infinitesimal segment is (0,ρ₁), with a continuous curve equation at an arc segment OP₁ in a rectangular coordinate system given by:

$$\{ \begin{matrix}x = {O}_{1 x} + {ρ}_{1} cos θ \\ y = {O}_{1 y} + {ρ}_{1} sin θ\end{matrix}$$

from this, coordinates (P₁ₓ,P_{1y}) of a first interpolation point P₁ is calculated as:

$$\{ \begin{matrix}{P}_{1 x} = {O}_{1 x} + {ρ}_{1} cos {θ}_{1} \\ {P}_{1 y} = {O}_{1 y} + {ρ}_{1} sin {θ}_{1}\end{matrix}$$

due to tangency continuity between adjacent infinitesimal arcs, coordinates (O^{2x},O_{2y}) of a center O₂ of a second infinitesimal arc P₁P₂, the center O₁ of the OP₁, and the point of tangency P₁ are on a same straight line, further obtaining the following equations:

$$\{ \begin{matrix}{P}_{1 x} = {O}_{2 x} + {ρ}_{2} cos {θ}_{1} \\ {P}_{1 y} = {O}_{2 y} + {ρ}_{2} sin {θ}_{1}\end{matrix}$$

the above two equations are combined to obtain the coordinates (O₂ₓ,O_{2y}) of the center O₂ of the second infinitesimal arc, denoted as:

$$\{ \begin{matrix}{O}_{2 x} = {O}_{1 x} + ( {ρ}_{1} - {ρ}_{2} ) cos {θ}_{1} \\ {O}_{2 y} = {O}_{1 y} + ( {ρ}_{1} - {ρ}_{2} ) sin {θ}_{1}\end{matrix}$$

a continuous curve equation of the second infinitesimal arc P₁P₂ is further obtained, denoted as:

$$\{ \begin{matrix}x = {O}_{2 x} + {ρ}_{2} cos θ = {O}_{1 x} + ( {ρ}_{1} - {ρ}_{2} ) cos {θ}_{1} + {p}_{2} cos θ \\ y = {O}_{2 y} + {ρ}_{2} sin θ = {O}_{1 y} + ( {ρ}_{1} - {ρ}_{2} ) sin {θ}_{1} + {p}_{2} sin θ\end{matrix}$$

building upon the above procedure, coordinates (O₍ᵢ₋₁₎ₓ,O_{(i-1)y}) of a center Oᵢ₋₁ of an i−1th infinitesimal arc, curvature data ρᵢ₋₁, an included angle θᵢ₋₁, and ith interpolated curvature data ρᵢ are obtained, with a continuous curve equation for an ith infinitesimal arc Pᵢ₋₁Pᵢ given by:

$$\{ \begin{matrix}x = {O}_{( i - 1 ) x} + ( {ρ}_{i - 1} - {ρ}_{i} ) cos {θ}_{i - 1} + {ρ}_{i} cos θ \\ y = {O}_{( i - 1 ) y} + ( {ρ}_{i - 1} - {ρ}_{i} ) sin {θ}_{i - 1} + {ρ}_{i} sin θ\end{matrix}$$

where θᵢ=θᵢ₋₁+s/ρᵢ; and
recursion proceeds sequentially until iteration i=n+1, and mid-section position point coordinates

$$( {x}_{b o t - mid}^{*} , {y}_{b o t - m i d}^{*} )$$

of the continuous curve are derived;
S43, deriving the continuous curve equation for the ith infinitesimal arc Pᵢ₋₁Pᵢ through a top-down recursive process based on the computational process of S42, with the surface platform position as a starting point:

$$\{ \begin{matrix}x = {x}_{s u r}^{*} + {O}_{( i - 1 ) x} + ( {ρ}_{i - 1} - {ρ}_{i} ) cos {θ}_{i - 1} + {ρ}_{i} cos θ \\ y = {y}_{s u r}^{*} + {O}_{( i - 1 ) y} + ( {ρ}_{i - 1} - {ρ}_{i} ) sin {θ}_{i - 1} + {ρ}_{i} sin θ\end{matrix}$$

proceeding sequentially until reaching i=n+1, and acquiring mid-section position point coordinates

$$( {x}_{sur - mid}^{*} , {y}_{sur - mid}^{*} )$$

of the continuous curve through the top-down recursive process; and
S44, integrating the upper and lower segments to obtain the full-length continuous curve equation, wherein:
based on the upper segment's continuous curve equation and the lower segment's continuous curve equation, the full-length continuous curve equation is obtained; and y is calculated at any position x, where y represents the inverted displacement data corresponding to the outer surface position of the deepwater riser structure.

Preferably, the method further includes a displacement inversion correction process based on the riser mid-section position, including the steps of:
comparing mid-section position relative errors from both top-down and bottom-up recursive processes with a mid-section position relative error of an actual riser, expanding the number of interpolated discrete curvature data points using the interpolation method if the relative error exceeds a predetermined threshold, and reducing the spacing between adjacent interpolated curvature data points to mitigate the mid-section position relative error of the inverted riser; and
maintaining the mid-section position relative errors from both the top-down and bottom-up recursive processes below the predetermined threshold, integrating the upper and lower segment continuous curve equations into the full-length curve equation, plotting a continuous smooth curve based on the inverted displacement data, and acquiring the displacement at any position along the deepwater riser to complete the displacement inversion.

Preferably, the relative error is calculated as:

$$\{ \begin{matrix}{E}_{bot - mid} = \frac{\vert \sqrt{{x}_{bot - mid}^{* 2} + {y}_{bot - mid}^{* 2}} - \sqrt{{x}_{mid}^{* 2} + {y}_{mid}^{* 2}} \vert}{\sqrt{{x}_{mid}^{* 2} + {y}_{mid}^{* 2}}} \times 100 \% \\ {E}_{sur - mid} = \frac{\vert \sqrt{{x}_{sur - mid}^{* 2} + {y}_{sur - mid}^{* 2}} - \sqrt{{x}_{mid}^{* 2} + {y}_{mid}^{* 2}} \vert}{\sqrt{{x}_{mid}^{* 2} + {y}_{mid}^{* 2}}} \times 100 \%\end{matrix}$$

where E_{bot-mid} represents a relative error accumulated during the recursive progression from the bottom end to the mid-section, E_{sur-mid} represents a relative error accumulated during the recursive progression from the surface to the mid-section,

$$( {x}_{bot - mid}^{*} , {y}_{bot - mid}^{*} )$$

represents mid-section position coordinates derived through the recursive progression from the bottom end to the mid-section,

$$( {x}_{sur - mid}^{*} , {y}_{sur - mid}^{*} )$$

represents mid-section position coordinates derived through the recursive progression from the surface to the mid-section, and

$$( {x}_{mid}^{*} , {y}_{m i d}^{*} )$$

represents riser mid-section relative position coordinates calculated based on: the bottom position beacon information (x_{bot},y_{bot}) of the deepwater riser, the mid-section position beacon information (x_{mid},y_{mid}) of the riser, and the surface offshore platform position GPS-derived information (xₛᵤᵣ,yₛᵤᵣ), with the coordinate origin (0,0) at the bottom position of the deepwater riser.

Preferably, if the mid-section position relative error derived only from the top-down recursive process exceeds the predetermined threshold, refined interpolation is performed on the lower segment's discrete curvature data, requiring at least doubling the number of interpolated data points in S2, followed by execution of a two-end recursion and relative error calculation;
if the mid-section position relative error derived only from the bottom-up recursive process exceeds the predetermined threshold, refined interpolation is applied to the upper segment's discrete curvature data, necessitating at least doubling the number of interpolated points in S2, followed by re-execution of the two-end recursion and relative error calculation; and
if the mid-section position relative errors derived from both the bottom-up and top-down recursive processes exceed the predetermined threshold, the number of interpolated discrete curvature data points in S2 is at least doubled, and the two-end recursion and relative error calculation are performed again.

Compared with the related art, the present disclosure has the following beneficial effects.
1. The real-time displacement inversion of the deepwater riser structure is performed based on the sparse, discrete curvature data, eliminating the need to derive a relationship between structural strain and curvature, making it applicable to a wider range of structural forms (e.g., steel pipes, flexible pipes, and composite pipes). It can also be extended to long-distance mooring lines and cable structures.
2. The cumulative error mitigation strategy can effectively address the end-point error amplification effect inherent in traditional spatial curve reconstruction methods, significantly improving the accuracy of displacement inversion at the bottom of the deepwater riser. Additionally, a mid-section error correction solution is employed to reduce the maximum error during displacement inversion, which is critical for the inspection and monitoring of subsea production systems.
3. The displacement inversion of the deepwater riser structure can be achieved using only a limited number of curvature monitoring sensors and the mid-section position beacon. The interpolation frequency is dynamically adjusted in real time based on correction errors. Moreover, this method has the advantages of low detection cost, high inversion accuracy, and rapid computation rate.

### BRIEF DESCRIPTION OF THE DRAWINGS

FIG. 1 is an overall flowchart of an inversion method according to the present disclosure.

FIG. 2 is a schematic diagram of a deepwater oil and gas riser layout scenario according to the present disclosure.

FIG. 3 is a schematic diagram of an inversion computational process according to the present disclosure.

FIG. 4 is a comparison diagram of an inverted displacement and a true displacement for a deepwater riser structure according to an embodiment of the present disclosure.

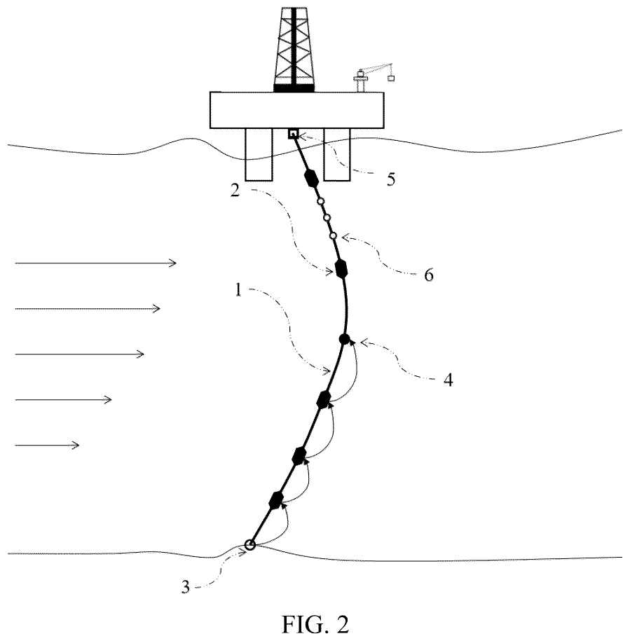

Reference numerals and denotations thereof in FIG. 2: 1—deepwater riser; 2—curvature sensor; 3—bottom beacon; 4—mid-section beacon; 5—surface platform GPS; and 6—interpolation position.

### DETAILED DESCRIPTION

The present disclosure is further described below in combination with embodiments. Obviously, the embodiments described are only some, rather than all embodiments of the present disclosure. Based on the embodiments of the present disclosure, all other embodiments obtained by those ordinary skilled in the art without creative efforts fall within the scope of protection of the present disclosure.

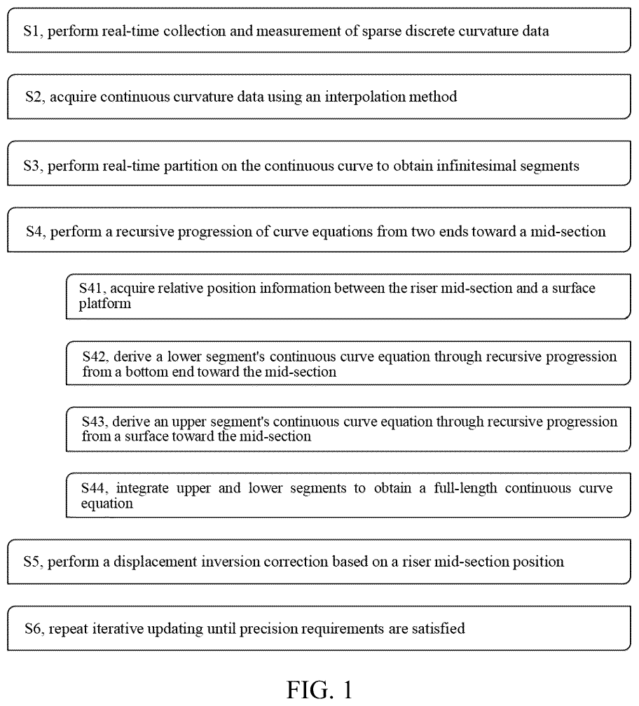

The present disclosure provides a displacement inversion method for a deepwater riser structure and a cumulative error mitigation strategy. An overall process is shown in FIG. 1, including the steps that:

In S1, real-time collection and measurement of sparse discrete curvature data are performed: n fiber-optic curvature sensors are mounted at a plurality of monitoring points of significant curvatures along a deepwater riser structure, and these sensors capture n measured sparse discrete curvature data

$${ρ}_{1}^{*} , {ρ}_{2}^{*} , … , {ρ}_{j}^{*} , … , {ρ}_{n}^{*}$$

in real time, where

$${ρ}_{j}^{*}$$

is jth measured curvature data. A deepwater oil and gas riser layout scenario is as shown in FIG. 2, including: a deepwater riser 1, the curvature sensors 2, a bottom beacon 3, a mid-section beacon 4, a surface platform GPS 5, and interpolation positions 6.

In S2, continuous curvature data are acquired using an interpolation method: based on the measured discrete curvature data

$${ρ}_{1}^{*} , {ρ}_{2}^{*} , … , {ρ}_{j}^{*} , … , {ρ}_{n}^{*}$$

and corresponding monitoring points, curvature interpolation is performed on n measured discrete curvature data using the piecewise cubic Hermite interpolation method, and m interpolated continuous curvature data ρ₁, ρ₂, . . . , ρᵢ, . . . , ρₘ are acquired, with ρᵢ representing ith interpolated curvature data; and the number of interpolated curvature data m is defined as m=n×2+1, with n representing the number of monitoring points.

In S3, real-time partition is performed on continuous curvature curve infinitesimal segments: a continuous curve is generated based on the m pieces of continuous curvature data and positional information, and the real-time partition is performed on the continuous curve to obtain lengths s of m+1 infinitesimal segments; and the infinitesimal segment length s of the riser is defined as a total length of the continuous curve divided by the number of the infinitesimal segments m+1.

In S4, a recursive progression of curve equations is performed from two ends toward a mid-section.

In S41, the relative position information between the riser mid-section and the surface platform is acquired.

Based on bottom position beacon information (x_{bot},y_{bot}) of the deepwater riser, mid-section position beacon information (x_{mid},y_{mid}) of the riser, and surface offshore platform position GPS-derived information (xₛᵤᵣ,yₛᵤᵣ), a riser mid-section relative position

$$( {x}_{mid}^{*} , {y}_{m i d}^{*} )$$

and a surface platform relative position

$$( {x}_{s u r}^{*} , {y}_{s u r}^{*} )$$

are calculated with a coordinate origin (0,0) at the bottom position of the deepwater riser, where these relative positions satisfy the following relationships:

$${x}_{m i d}^{*} = {x}_{m i d} - {x}_{b o t} , {y}_{m i d}^{*} = {y}_{m i d} - {y}_{b o t} , {x}_{s u r}^{*} = {x}_{s u r} - {x}_{b o t} , and {y}_{s u r}^{*} = {y}_{s u r} - {y}_{b o t} .$$

In S42, a lower segment's continuous curve equation is derived through recursive progression from a bottom end toward the mid-section.

A coordinate system is established with the coordinate origin at a riser bottom-end position, with a tangent direction at a starting point defined as an x-axis, and a vertical line at the starting point defined as a y-axis; and an infinitesimal arc length between two points on the continuous curve is denoted as s, Pᵢ represents an ith interpolation point, Oᵢ and ρᵢ represent a center of an ith infinitesimal arc segment and curvature data (or a curvature radius), and θᵢ represents an included angle between ρᵢ Oᵢ and a horizontal line.

Coordinates of a center O₁(O₁ₓ,O_{1y}) of a first infinitesimal segment are (0,ρ₁), with a continuous curve equation at an arc segment OP₁ in a rectangular coordinate system given by:

$$\{ \begin{matrix}x = {O}_{1 x} + {ρ}_{1} cos θ \\ y = {O}_{1 y} + {ρ}_{1} sin θ\end{matrix}$$

From this, coordinates (P₁ₓ,P_{1y}) of a first interpolation point P₁ is calculated as:

$$\{ \text{} \begin{matrix}{P}_{1 x} = {O}_{1 x} + {ρ}_{1} cos {θ}_{1} \\ {P}_{1 y} = {O}_{1 y} + {ρ}_{1} sin {θ}_{1}\end{matrix}$$

Due to tangency continuity between adjacent infinitesimal arcs, coordinates (O₂ₓ,O_{2y}) of a center O₂ of a second infinitesimal arc P₁P₂, the center O₁ of the OP₁, and the point of tangency P₁ are on a same straight line, further obtaining the following equations:

$$\{ \text{} \begin{matrix}{P}_{1 x} = {O}_{2 x} + {ρ}_{2} cos {θ}_{1} \\ {P}_{1 y} = {O}_{2 y} + {ρ}_{2} sin {θ}_{1}\end{matrix} \text{}$$

The above two equations are combined to obtain the coordinates (O^{2x},O_{2y}) of the center O₂ of the second infinitesimal arc, denoted as:

$$\{ \text{} \begin{matrix}{O}_{2 x} = {O}_{1 x} + ( {ρ}_{1} - {ρ}_{2} ) cos {θ}_{1} \\ {O}_{2 y} = {O}_{1 y} + ( {ρ}_{1} - {ρ}_{2} ) sin {θ}_{1}\end{matrix} \text{}$$

A continuous curve equation of the second infinitesimal arc P₁P₂ is further obtained, denoted as:

$$\{ \text{} \begin{matrix}x = {O}_{2 x} + {ρ}_{2} cos θ = {O}_{1 x} + ( {ρ}_{1} - {ρ}_{2} ) cos {θ}_{1} + {ρ}_{2} cos θ \\ y = {O}_{2 y} + {ρ}_{2} sin θ = {O}_{1 y} + ( {ρ}_{1} - {ρ}_{2} ) sin {θ}_{1} + {ρ}_{2} sin θ\end{matrix} \text{}$$

Building upon the above procedure, coordinates (O₍ᵢ₋₁₎ₓ,O_{(i-1)y}) of a center Oᵢ₋₁ of an i−1th infinitesimal arc, curvature data ρᵢ₋₁, an included angle θᵢ₋₁, and ith interpolated curvature data ρᵢ are obtained, with a continuous curve equation for an ith infinitesimal arc Pᵢ₋₁Pᵢ given by:

$$\{ \text{} \begin{matrix}x = {O}_{( i - 1 ) x} + ( {ρ}_{i - 1} - {ρ}_{i} ) cos {θ}_{i - 1} + {ρ}_{i} cos θ \\ y = {O}_{( i - 1 ) y} + ( {ρ}_{i - 1} - {ρ}_{i} ) sin {θ}_{i - 1} + {ρ}_{i} sin θ\end{matrix}$$

where θᵢ=θᵢ₋₁+s/ρᵢ.

Recursion proceeds sequentially until iteration i=n+1, and mid-section position point coordinates

$$( {x}_{bot - mid}^{*} , {y}_{bot - mid}^{*} )$$

of the continuous curve are derived, where the mid-section position point coordinates are as follows:

$${x}_{bot - mid}^{*} = {O}_{( i - 1 ) x} + ( {ρ}_{i - 1} - {ρ}_{i} ) cos {θ}_{i - 1} + {ρ}_{i} cos {θ}_{i}$$

$${y}_{bot - mid}^{*} = {O}_{( i - 1 ) y} + ( {ρ}_{i - 1} - {ρ}_{i} ) sin {θ}_{i - 1} + {ρ}_{i} sin {θ}_{i}$$

In S43, with the surface platform position as a starting point, the continuous curve equation for the ith infinitesimal arc Pᵢ₋₁Pᵢ is derived through a top-down recursive process based on the computational process from S42:

$$\{ \text{} \begin{matrix}x = {x}_{sur}^{*} + {O}_{( i - 1 ) x} + ( {ρ}_{i - 1} - {ρ}_{i} ) cos {θ}_{i - 1} + {ρ}_{i} cos θ \\ y = {y}_{sur}^{*} {O}_{( i - 1 ) y} + ( {ρ}_{i - 1} - {ρ}_{i} ) sin {θ}_{i - 1} + {ρ}_{i} sin θ\end{matrix}$$

The recursion proceeds sequentially until iteration i=n+1, thereby acquiring mid-section position point coordinates

$$( {x}_{sur - mid}^{*} , {y}_{sur - mid}^{*} )$$

of the continuous curve through the top-down recursive process.

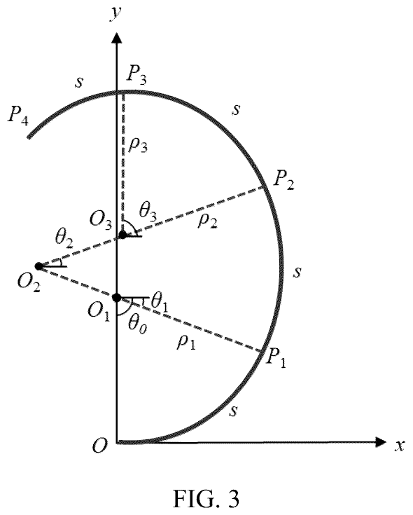

An inversion computational process is shown in FIG. 3.

In S44, upper and lower segments are integrated to obtain a full-length continuous curve equation.

Based on an upper segment's continuous curve equation and the lower segment's continuous curve equation, the full-length continuous curve equation is obtained; and y is calculated at any position x, where y represents inverted displacement data corresponding to an outer surface position of the deepwater riser structure.

In S5, a displacement inversion correction is performed based on the riser mid-section position, including the steps that:
mid-section position relative errors from both top-down and bottom-up recursive processes are compared with a mid-section position relative error of an actual riser. If the relative error exceeds a predetermined threshold, the number of interpolated discrete curvature data points is expanded using the interpolation method, and the spacing between adjacent interpolated curvature data points is reduced to mitigate the relative error in the inverted riser mid-section position. Furthermore, the relative error is calculated as:

$$\{ \text{} \begin{matrix}{E}_{bot - mid} = \frac{\vert \sqrt{{x}_{bot - mid}^{* 2} + {y}_{bot - mid}^{* 2}} - \sqrt{{x}_{mid}^{* 2} + {y}_{mid}^{* 2}} \vert}{\sqrt{{x}_{mid}^{* 2} + {y}_{mid}^{* 2}}} \times 100 \% \\ {E}_{sur - mid} = \frac{\vert \sqrt{{x}_{sur - mid}^{* 2} + {y}_{sur - mid}^{* 2}} - \sqrt{{x}_{mid}^{* 2} + {y}_{mid}^{* 2}} \vert}{\sqrt{{x}_{mid}^{* 2} + {y}_{mid}^{* 2}}} \times 100 \%\end{matrix} \text{}$$

where E_{bot-mid} represents a relative error accumulated during the recursive progression from the bottom end to the mid-section, E_{sur-mid} represents a relative error accumulated during the recursive progression from the surface to the mid-section,

$$( {x}_{bot - mid}^{*} , {y}_{bot - mid}^{*} )$$

represents mid-section position coordinates derived through the recursive progression from the bottom end to the mid-section,

$$( {x}_{sur - mid}^{*} , {y}_{sur - mid}^{*} )$$

represents mid-section position coordinates derived through the recursive progression from the surface to the mid-section, and

$$( {x}_{mid}^{*} , {y}_{mid}^{*} )$$

represents riser mid-section relative position coordinates calculated based on: the bottom position beacon information (x_{bot},y_{bot}) of the deepwater riser, the mid-section position beacon information (x_{mid},y_{mid}) of the riser, and the surface offshore platform position GPS-derived information (xₛᵤᵣ,yₛᵤᵣ), with the coordinate origin (0,0) at the bottom position of the deepwater riser.

If the mid-section position relative error derived only from the top-down recursive process exceeds the predetermined threshold, refined interpolation is performed on the lower segment's discrete curvature data, requiring at least doubling the number of interpolated data points in S2, followed by execution of S42, S44, and S5.

If the mid-section position relative error derived only from the bottom-up recursive process exceeds the predetermined threshold, refined interpolation is applied to the upper segment's discrete curvature data, necessitating at least doubling the number of interpolated points in S2, followed by re-execution of S42, S44, and S5.

If the mid-section position relative errors derived from both the bottom-up and top-down recursive processes exceed the predetermined threshold, the number of interpolated discrete curvature data points in S2 is at least doubled, and S3, S4, and S5 are performed again.

In S6, iterative updating is repeated until precision requirements are satisfied: S5 is repeated until the relative errors at the mid-section positions from both top-down and bottom-up recursive processes are maintained below the predetermined threshold. At this time, the upper and lower segment continuous curve equations are integrated into the full-length curve equation, and a continuous smooth curve is plotted based on the inverted displacement data, thereby acquiring the displacement at any position along the deepwater riser to complete the displacement inversion.

In this embodiment, using a deepwater oil and gas riser as an implementation case for the present disclosure, the riser has a length of 20 m with fixed constraints applied at two ends, a density of 7,850 kg/m³, a Young's modulus of 206 GPa, and a Poisson's ratio of 0.3. Under uniform flow conditions, a distributed load with a magnitude of 500 N/m is applied along the structure.

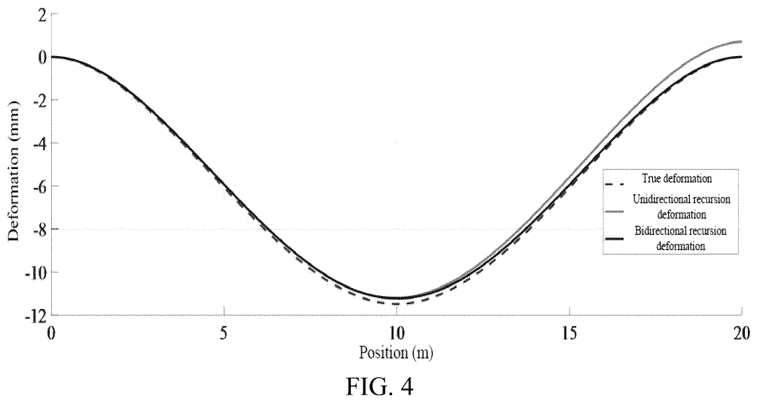

A unidirectional recursion is transitioned to bidirectional recursive progression, whereby simultaneous recursive progression from the two ends of the structure toward the mid-section, thereby eliminating accumulated errors in the latter segment. With eight monitoring points uniformly distributed along the riser, eight discrete curvature data points are acquired. Through 200 interpolation operations, 200 continuous curvature data points are generated. Riser displacement inversion is performed using the bidirectional recursive method proposed in the present disclosure. As shown in FIG. 4, it can be seen that a displacement inversion curve obtained through the bidirectional recursive method exhibits closer alignment with a true displacement curve. Furthermore, an average Euclidean distance for the bidirectional recursive method across 10-20 m is 0.1372, compared to 0.4987 for the unidirectional recursive method. This indicates that the bidirectional recursive method achieves significant error elimination at riser ends, decreasing the errors by 72.49%.

As shown in Table 1, the impact of varying monitoring point spacing on displacement inversion accuracy for both bidirectional and unidirectional recursive methods is examined. As the spacing between monitoring points increases, the average Euclidean distance progressively rises for both bidirectional and unidirectional recursive methods. However, the bidirectional method consistently yields lower average Euclidean distances than its unidirectional counterpart. At a monitoring point spacing of 2.5 m, the bidirectional recursive method achieves an error of 0.1372, outperforming the unidirectional method's 0.1400 error at 0.5 m spacing. Therefore, it can be seen that the bidirectional recursive method can realize precise structural displacement inversion using merely one-fifth the number of sensors required by the unidirectional recursive method. Consequently, it has the advantages of lower detection costs, higher monitoring accuracy, and broader practical applicability.

TABLE 1
Recursive errors under varying monitoring point spacing

| Region | | | | | |
|---|---|---|---|---|---|
| of | | Monitoring point spacing | | | |
| Interest | Recursive method | 0.5 m | 1 m | 2 m | 2.5 m |
| 10-20 m | Unidirectional | 0.1400 | 0.1795 | 0.3584 | 0.4987 |
| | recursion error | | | | |
| | Bidirectional | 0.1321 | 0.1322 | 0.1342 | 0.1372 |
| | recursion error | | | | |
| | Error reduction rate | 5.64% | 26.35% | 62.56% | 72.49% |
| 0-20 m | Unidirectional | 0.1349 | 0.1547 | 0.2451 | 0.3167 |
| | recursion error | | | | |
| | Bidirectional | 0.1309 | 0.1311 | 0.1331 | 0.1360 |
| | recursion error | | | | |
| | Error reduction rate | 2.96% | 15.26% | 45.70% | 57.06% |

The foregoing is only the preferred embodiment of the present application, rather than limiting the present application. A person skilled in the art may make various modifications and adaptations to the present application. Any modifications, equivalent substitutions, or improvements made within the spirit and principles of the present application fall within the scope of protection of the present application.

Although specific implementations of the present disclosure have been described above, these implementations do not limit the scope of protection of the present disclosure. A person skilled in the art recognizes that various modifications or variations effected without creative effort based on the technical solutions of the present disclosure fall within the scope of protection of the present disclosure.

1. A displacement inversion method for a deepwater riser structure, comprising the steps of
S1, performing real-time collection and measurement of sparse discrete curvature data based on n curvature sensors mounted at a plurality of monitoring points along a deepwater riser structure;
S2, acquiring m pieces of continuous curvature data using an interpolation method;
S3, generating a continuous curve based on the m pieces of continuous curvature data and positional information, and performing real-time partition on the continuous curve to obtain lengths s of m+1 infinitesimal segments; and
S4, acquiring relative position information between a riser mid-section and a surface platform, deriving a lower segment's continuous curve equation through recursive progression from a bottom end toward the mid-section, while deriving an upper segment's continuous curve equation through recursive progression from the surface toward the mid-section, integrating the upper and lower segments to obtain a full-length continuous curve equation, and calculating y at any position x, with y representing inverted displacement data corresponding to an outer side position of the deepwater riser structure; and comprising a specific process as follows:
S41, acquiring the relative position information between the riser mid-section and the surface platform, wherein:
based on bottom position beacon information (x_{bot}, y_{bot}) of the deepwater riser, mid-section position beacon information (x_{mid}, y_{mid}) of the riser, and surface offshore platform position global position system (GPS)-derived information (xₛᵤᵣ,yₛᵤᵣ), a riser mid-section relative position
$$( {x}_{mid}^{*} , {y}_{mid}^{*} )$$
and a surface platform relative position
$$( {x}_{sur}^{*} , {y}_{sur}^{*} )$$
are calculated with a coordinate origin (0,0) at the bottom position of the deepwater riser, where these relative positions satisfy the following relationships:
$${x}_{mid}^{*} = {x}_{mid} - {x}_{bot} ,$$
$${y}_{mid}^{*} = {y}_{mid} - {y}_{bot} ,$$
$${x}_{sur}^{*} = {x}_{sur} - {x}_{bot} ,$$
$$and$$
$${y}_{sur}^{*} = {y}_{sur} - {y}_{bot} ;$$
S42, deriving the lower segment's continuous curve equation through the recursive progression from the bottom end toward the mid-section, wherein:
a coordinate system is established with the coordinate origin at a riser bottom-end position, with a tangent direction at a starting point defined as an x-axis, and a vertical line at the starting point defined as a y-axis; and an infinitesimal arc length between two points on the continuous curve is denoted as s, Pᵢ represents an ith interpolation point, Oᵢ and ρᵢ represent a center of an ith infinitesimal arc segment and curvature data (or a curvature radius), and θᵢ represents an included angle between PᵢOᵢ and a horizontal line;
coordinates of a center O₁(O₁ₓ,O_{1y}) of a first infinitesimal segment is (0,ρ₁), with a continuous curve equation at an arc segment OP₁ in a rectangular coordinate system given by:
$$\{ \begin{matrix}x = {O}_{1 x} + {ρ}_{1} cos θ \\ y = {O}_{1 y} + {ρ}_{1} sin θ\end{matrix}$$
from this, coordinates (P₁ₓ, P_{1y}) of a first interpolation point P₁ is calculated as:
$$\{ \begin{matrix}{P}_{1 x} = {O}_{1 x} + {ρ}_{1} cos {θ}_{1} \\ {P}_{1 y} = {O}_{1 y} + {ρ}_{1} sin {θ}_{1}\end{matrix}$$
due to tangency continuity between adjacent infinitesimal arcs, coordinates (O^{2x}, O_{2y}) of a center O₂ of a second infinitesimal arc P₁P₂, the center O₁ of the OP₁, and the point of tangency P₁ are on a same straight line, further obtaining the following equations:
$$\{ \begin{matrix}{P}_{1 x} = {O}_{2 x} + {ρ}_{2} cos {θ}_{1} \\ {P}_{1 y} = {O}_{2 y} + {ρ}_{2} sin {θ}_{1}\end{matrix}$$
the above two equations are combined to obtain the coordinates (O^{2x}, O_{2y}) of the center O₂ of the second infinitesimal arc, denoted as:
$$\{ \begin{matrix}{O}_{2 x} = {O}_{1 x} + ( {ρ}_{1} - {ρ}_{2} ) cos {θ}_{1} \\ {O}_{2 y} = {O}_{1 y} + ( {ρ}_{1} - {ρ}_{2} ) sin {θ}_{1}\end{matrix}$$
a continuous curve equation of the second infinitesimal arc P₁P₂ is further obtained, denoted as:
$$\{ \begin{matrix}x = {O}_{2 x} + {ρ}_{2} cos θ = {O}_{1 x} + ( {ρ}_{1} - {ρ}_{2} ) cos {θ}_{1} + {ρ}_{2} cos θ \\ y = {O}_{2 y} + {ρ}_{2} sin θ = {O}_{1 y} + ( {ρ}_{1} - {ρ}_{2} ) sin {θ}_{1} + {ρ}_{2} sin θ\end{matrix}$$
building upon the above procedure, coordinates (O₍ᵢ₋₁₎ₓ,O_{(i-1)y}) of a center Oᵢ₋₁ of an i−1th infinitesimal arc, curvature data ρᵢ₋₁, an included angle θᵢ₋₁, and ith interpolated curvature data ρᵢ are obtained, with a continuous curve equation for an ith infinitesimal arc ρᵢ₋₁ρᵢ given by:
$$\{ \begin{matrix}x = {O}_{( i - 1 ) x} + ( {ρ}_{i - 1} - {ρ}_{i} ) cos {θ}_{i - 1} + {ρ}_{i} cos θ \\ y = {O}_{( i - 1 ) y} + ( {ρ}_{i - 1} - {ρ}_{i} ) sin {θ}_{i - 1} + {ρ}_{i} sin θ\end{matrix}$$
where θᵢ=θᵢ₋₁+s/ρᵢ; and
recursion proceeds sequentially until iteration i=n+1, and mid-section position point coordinates
$$( {x}_{bot - mid}^{*} , {y}_{bot - mid}^{*} )$$
of the continuous curve are derived;
S43, deriving the continuous curve equation for the ith infinitesimal arc Pᵢ₋₁Pᵢ through a top-down recursive process based on the computational process of S42, with the surface platform position as a starting point:
$$\{ \begin{matrix}x = {x}_{sur}^{*} + {O}_{( i - 1 ) x} + ( {ρ}_{i - 1} - {ρ}_{i} ) cos {θ}_{i - 1} + {ρ}_{i} cos θ \\ y = {y}_{sur}^{*} + {O}_{( i - 1 ) y} + ( {ρ}_{i - 1} - {ρ}_{i} ) sin {θ}_{i - 1} + {ρ}_{i} sin θ\end{matrix}$$
proceeding sequentially until reaching i=n+1, and acquiring mid-section position point coordinates
$$( {x}_{sur - mid}^{*} , {y}_{sur - mid}^{*} )$$
of the continuous curve through the top-down recursive process; and
S44, integrating the upper and lower segments to obtain the full-length continuous curve equation, wherein:
based on the upper segment's continuous curve equation and the lower segment's continuous curve equation, the full-length continuous curve equation is obtained; and y is calculated at any position x, where y represents the inverted displacement data corresponding to the outer surface position of the deepwater riser structure.

2. The displacement inversion method for a deepwater riser structure according to claim 1, wherein in S2, the acquiring m pieces of continuous curvature data using an interpolation method specifically comprises the steps of:
performing curvature interpolation on n measured discrete curvature data using the piecewise cubic Hermite interpolation method, based on the measured discrete curvature data
$${ρ}_{1}^{*} , {ρ}_{2}^{*} , … , {ρ}_{j}^{*} , … , {ρ}_{n}^{*}$$
and corresponding monitoring points, and acquiring m interpolated continuous curvature data ρᵢ, ρ₂, . . . , ρᵢ, . . . , ρₘ, where ρᵢ represents ith interpolated curvature data, and the number of interpolated curvature data m is defined as m=n×2+1, with n representing the number of monitoring points.

3. The displacement inversion method for a deepwater riser structure according to claim 1, the method further comprises a displacement inversion correction process based on the riser mid-section position, comprising the steps of:
comparing mid-section position relative errors from both top-down and bottom-up recursive processes with a mid-section position relative error of an actual riser, expanding the number of interpolated discrete curvature data points using the interpolation method if the relative error exceeds a predetermined threshold, and reducing the spacing between adjacent interpolated curvature data points to mitigate the mid-section position relative error of the inverted riser; and
maintaining the mid-section position relative errors from both the top-down and bottom-up recursive processes below the predetermined threshold, integrating the upper and lower segment continuous curve equations into the full-length curve equation, plotting a continuous smooth curve based on the inverted displacement data, and acquiring the displacement at any position along the deepwater riser to complete the displacement inversion.

4. The displacement inversion method for a deepwater riser structure according to claim 3, wherein the relative error is calculated as:
$$\{ \begin{matrix}{E}_{bot - mid} = \frac{\vert \sqrt{{x}_{bot - mid}^{* 2} + {y}_{bot - mid}^{* 2}} - \sqrt{{x}_{mid}^{* 2} + {y}_{mid}^{* 2}} \vert}{\sqrt{{x}_{mid}^{* 2} + {y}_{mid}^{* 2}}} \times 100 \% \\ {E}_{sur - mid} = \frac{\vert \sqrt{{x}_{sur - mid}^{* 2} + {y}_{sur - mid}^{* 2}} - \sqrt{{x}_{mid}^{* 2} + {y}_{mid}^{* 2}} \vert}{\sqrt{{x}_{mid}^{* 2} + {y}_{mid}^{* 2}}} \times 100 \%\end{matrix}$$
where E_{bot-mid} represents a relative error accumulated during the recursive progression from the bottom end to the mid-section, E_{sur-mid} represents a relative error accumulated during the recursive progression from the surface to the mid-section,
$$( {x}_{bot - mid}^{*} , {y}_{bot - mid}^{*} )$$
represent mid-section position coordinates derived through the recursive progression from the bottom end to the mid-section,
$$( {x}_{sur - mid}^{*} , {y}_{sur - mid}^{*} )$$
represents mid-section position coordinates derived through the recursive progression from the surface to the mid-section, and
$$( {x}_{mid}^{*} , {y}_{mid}^{*} )$$
represents riser mid-section relative position coordinates calculated based on: the bottom position beacon information (x_{bot},y_{bot}) of the deepwater riser, the mid-section position beacon information (x_{mid}, y_{mid}) of the riser, and the surface offshore platform position GPS-derived information (xₛᵤᵣ, yₛᵤᵣ), with the coordinate origin (0,0) at the bottom position of the deepwater riser.

5. The displacement inversion method for a deepwater riser structure according to claim 3, wherein:
if the mid-section position relative error derived only from the top-down recursive process exceeds the predetermined threshold, refined interpolation is performed on the lower segment's discrete curvature data, requiring at least doubling the number of interpolated data points in S2, followed by execution of a two-end recursion and relative error calculation;
if the mid-section position relative error derived only from the bottom-up recursive process exceeds the predetermined threshold, refined interpolation is applied to the upper segment's discrete curvature data, necessitating at least doubling the number of interpolated points in S2, followed by re-execution of the two-end recursion and relative error calculation; and
if the mid-section position relative errors derived from both the bottom-up and top-down recursive processes exceed the predetermined threshold, the number of interpolated discrete curvature data points in S2 is at least doubled, and the two-end recursion and relative error calculation are performed.
